(19) United States
(12) Patent Application Publication
(10) Pub. No.: US 2017/0165941 A1
(43) Pub. Date: Jun. 15, 2017

(54) MULTI-LAYER FABRIC REINFORCED CEMENTITIOUS MATRIX AND APPLICATION METHOD THEREOF

(71) Applicant: NANO AND ADVANCED MATERIALS INSTITUTE LIMITED, SHATIN (HK)

(72) Inventors: Bo LI, KOWLOON (HK); Tung-chai LING, KOWLOON (HK); Bin-meng CHEN, KOWLOON (HK); Kai-tai WAN, KOWLOON (HK); Yi-fei YAN, KOWLOON (HK); Yuet-kee LAM, KOWLOON (HK); Man Lung SHAM, KOWLOON (HK)

(21) Appl. No.: 14/964,598

(22) Filed: Dec. 10, 2015

(51) Int. Cl. B32B 5/26; B32B 37/14; B32B 5/02

(52) U.S. Cl. CPC B32B 5/26; B32B 5/024; B32B 5/022; B32B 37/14; B32B 2260/044; B32B 2260/023; B32B 2305/08; B32B 2262/065; B32B 2262/101; B32B 2262/10; B32B 2305/07

(57) ABSTRACT

This disclosure provides an eco-friendly multi-layer fabric reinforced cementitious matrix (FRCM) enhanced by nanoparticles. The FRCM is developed for structural strengthening and/or repairing in reinforced concrete buildings. The FRCM consists of multi-layer fabrics as load-carrying and crack control components and a cementitious matrix as bedding for the fabric layers. The cementitious matrix is eco-friendly based on a main constituent of ground granulated blast-furnace slag (GGBS) and recycled glass cullets. Some additions, including nanoparticles, superplasticizer, hydroxy propyl methyl cellulose and/or starch ether, are added to achieve proper workability and rheology for application requirements, and to enhance fresh properties, mechanical properties and/or durability. Man-made fabric and natural fabric are embedded in the cementitious matrix with designated purposes of load carrying and crack control.

### TECHNICAL FIELD

This disclosure generally relates to building field, and particularly to a fabric reinforced cementitious matrix (FRCM) and an application method thereof.

### BACKGROUND

The most common degradation of reinforced concrete structures is steel corrosion. It is normally accompanied by spalling of concrete cover. This weakens structural factor of safety as well as fire resistance below a design value. Thus, a proper strengthening/repair work is required. There are several strengthening technologies available for corroded reinforced concrete structures. They include (i) bolting an external steel plate as additional reinforcement, (ii) removing the corroded steel reinforcement bar and replacing it by welding a new one, and (iii) using fibre reinforced polymer (FRP) laminates which have gained popularity for structural strengthening and/or repair. However, there are limitations in each method. For instance, additional protections are required to prevent corrosion for the added external steel plate; it is required to resist fire for the FRP due to its poor fire resistance attributed to poor fire resistance of organic binder (which is normally polymeric epoxy); and replacement of the corroded reinforcements is labor intensive. Hence, an innovative repair/strengthening material is needed.

### SUMMARY OF THIS DISCLOSURE

This disclosure provides an eco-friendly multi-layer fabric reinforced cementitious matrix (FRCM) enhanced by nanoparticles. The FRCM is developed for structural strengthening and/or repairing in reinforced concrete buildings. The FRCM consists of multi-layer fabrics as load-carrying and crack control components and a cementitious matrix as bedding for the fabric layers. The cementitious matrix is mainly prepared from sustainable solid material to develop eco-friendly activity, where the solid material is based on ordinary Portland cement, ground granulated blast-furnace slag (GGBS) and recycled glass cullet. Some additions, including nanoparticles, superplasticizer, hydroxy propyl methyl cellulose and/or starch ether, are added to achieve proper workability and rheology for application requirements. Specifically, the nanoparticles including nano-silica particles and/or nano-clay particles are used for enhancing fresh properties, mechanical properties and/or durability. Moreover, man-made fabric and natural fabric are embedded in the cementitious matrix with designated purposes of load carrying and crack control.

In one aspect, a fabric reinforced cementitious matrix (FRCM) is provided, which can include a cementitious matrix and multiple fabric reinforcement layers embedded within the cementitious matrix. The FRCM can be applied to a concrete substrate through a bonding agent, where the multiple fabric reinforcement layers embedded in the FRCM can function as load carrying and crack control.

In another aspect, a fabric reinforced cementitious matrix (FRCM), which is capable of being applied to a concrete substrate, is also provided. The FRCM can include a cementitious matrix and multiple fabric reinforcement layers embedded within the cementitious matrix. The cementitious matrix may include at least 70 weight percentages wasted or recycled materials to become sustainable. The multiple fabric reinforcement layers can be consisted of one or more first fabric layer(s) for load carrying and one or more second fabric layer(s) for crack control, where the first fabric layer(s) and the second fabric layer(s) are respectively located adjacent to an inner side and an outer side of the cementitious matrix.

In some embodiments of this disclosure, the cementitious matrix may also include nanoparticles. For example, nano-silica and/or nano-clay particles can be used as the nanoparticles to improve mechanical and fresh properties of the FRCM.

In some embodiments of this disclosure, the FRCM is eco-friendly due to the wasted or recycled materials included in the cementitious matrix. The cementitious matrix can be developed based on ground granulated blast-furnace slag and recycled glass cullet.

In still another aspect, a method is provided for applying a fabric reinforced cementitious matrix to a concrete substrate, which can include: applying a bonding agent onto the concrete substrate; applying a first layer of a cementitious matrix on the concrete substrate that is coated with the bonding agent; laying multiple fabric reinforcement layers that are spaced from each other on the first layer of the cementitious matrix, and coating the multiple fabric reinforcement layers with a further second layer of the cementitious matrix, such that the multiple fabric reinforcement layers are embedded within the cementitious matrix. Here, the multiple fabric reinforcement layers may include one or more first fabric layer(s) for load carrying and one or more second fabric layer(s) for crack control, and the method can further include: applying one layer of the cementitious matrix having a thickness of at least 5 mm between each of the first fabric layer(s) and the second fabric layer(s), such that the fabric layer and the layer of the cementitious matrix are interlaced with each other.

### BRIEF DESCRIPTION OF THE DRAWINGS

Following detailed descriptions of respective embodiments in this disclosure can be understood better when combining with these figures, in which the same structure is represented by the same reference sign. In the figures:

FIG. 1 is a schematic diagram for a fabric reinforced cementitious matrix (FRCM), where the FRCM is bonded to a concrete substrate through a bonding agent here; and

FIG. 2 is a flow chart illustrating how to apply a fabric reinforced cementitious matrix onto a concrete substrate.

### DETAILED DESCRIPTION

In order to make objectives, technical solutions and advantages of this disclosure be understood more clearly, this disclosure will be further described in detail with reference to specific embodiments and figures. It should be understood that those specific implementations described herein are merely for explaining rather than limiting this disclosure.

Embodiments of this disclosure provide a multi-layer fabric reinforced cementitious matrix (FRCM) with both excellent fire resistance and structural strengthening/repairing. The FRCM can include a cementitious matrix having wasted or recycled material as its main constituents, and multiple fabric reinforcement layers embedded within the cementitious matrix to offer both load carrying and crack control functions for a concrete structure. Such FRCM is eco-friendly and sustainable. Also, due to good fire resistance of cementitious material acting as a main-body structure of the FRCM and arrangement of the multiple fabric reinforcement layers within the FRCM, the FRCM can exhibit much better inherent fire resistance property as compared with other strengthening/repairing materials, such as an FRP material. Moreover, the FRCM can be provided with enhanced mechanical property, durability and fresh property when nanoparticles are used as the additions in the cementitious matrix.

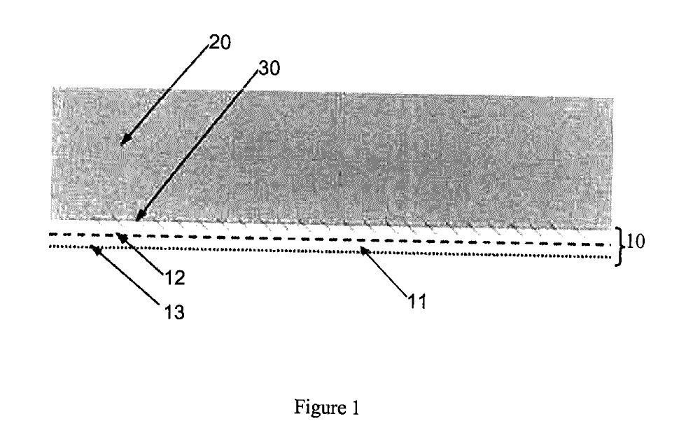

Referring to FIG. 1, it is a schematic diagram for an FRCM 10 in an embodiment of this disclosure. The FRCM 10 here includes a cementitious matrix 11, a first fabric layer 12 for load carrying and a second fabric layer 13 for crack control, where both the first and the second fabric layers 12 and 13 are directly embedded within the cementitious matrix 11, i.e., the cementitious matrix 11 acts as bedding for the two fabric layers in case of no specialized agent is required. FIG. 1 also shows a concrete substrate 20 that is bonded with the FRCM 10 through a bonding layer 30 formed by a bonding agent. In this case, the cementitious matrix 11 also acts as bedding for the bonding agent without usage of any other specialized composition. As shown in FIG. 1, the FRCM in this embodiment can be applied to the concrete substrate through the bonding agent, where the multiple fabric reinforcement layers (i.e., the first fabric layer 12 and the second fabric layer 13) become directly embedded within the cementitious matrix 11 in the application process. The cementitious matrix 11 is compatible with the concrete substrate 20, and thus a surface treatment can be simplified for the FRCM 10. The bonding agent can improve bond strength of the FRCM without polymer modification, and some examples for formula of the bonding agent will be explained below. Alternatively, proposed the concrete substrate to be repaired is rough enough the FRCM can be directly applied onto the concrete substrate without any bonding agent.

The fabric reinforcement layers mentioned above have designated purposes. It is noted that at least two fabric layers with respective functions are included in the cementitious material. Specifically, one or more fabric layer(s) for load carrying and one or more fabric layer(s) for crack control are respectively provided in the FRCM. The quantity of the layers depends on strengthening requirement which is further based on loading capacity of a concrete structural member to be repaired.

The fabric layer(s) for load carrying may be man-made fabric having high strength, where woven or unwoven high performance basalt or glass fibre is some specific man-made fabric suitable for the FRCM of this disclosure. The fabric layer(s) for crack control may be natural fabric such as woven or unwoven natural flax or cotton fiber. Specifically, flax, bamboo or other natural fibre in form of filament or yarn can be used for the crack control layer. Those natural fabrics that have a melting temperature of around 200° C. can provide connected routes for water evaporation after melting of fibers, thereby further improving the fire resistance property of the FRCM by ensuring a more effective water evaporation route to eliminate spalling of a repaired concrete. Those fabric layers both for load carrying and crack control are respectively made into an independent mesh to be embedded within the cementitious matrix. The weaving density of the mesh can affect the designated performance of the fabric reinforcement layers.

Attributed to their designated purposes, the layer(s) for load carrying should be located close to the concrete structural member, while another layer(s) for crack control is required to be close to an outer surface of the FRCM. Such arrangement can enhance fire resistance capability since the man-made fabric for load carrying is moved away from the concrete surface and the natural fabric is disposed adjacent to the outer surface for improving water evaporation.

In detail, such arrangement has considered that the cementitious matrix may transfer heat from the surface to inside and the man-made fibre may become soften at high temperature. In such arrangement, there is enough distance between the outer surface of the cementitious matrix and the man-made fabric layer, and thus the man-made fabric layer can be kept below its softening temperature since the cementitious matrix is insulated from the heat transfer. Also, it takes a relatively long time to affect the man-made fabric layer if there is a fire accidence, and thus the repaired concrete building can exhibit better structural strength to provide better safety property.

For the purpose of obtaining an optimal mechanical property for the FRCM, the fabric layers are disposed to be in parallel to the surface of the concrete substrate. The thickness of the FRCM and a spacing between each fabric layer are further controlled to achieve better strengthening/repair effect. A common thickness for the FRCM ranges from substantially 10 mm to 40 mm, and the spacing of each fabric layer should be at least 4 mm corresponding to the thickness of the FRCM.

In this embodiment, specifically, the first fabric layer 12 functioning as load carrying is located adjacent to an inner side of the cementitious matrix 11 (i.e., close to the concrete substrate 20), while the second fabric layer 13 functioning as crack control is located adjacent to an outer side of the cementitious matrix 11. The first fabric layer 12 is a control mesh made of high performance man-made fabric, and the second fabric layer 13 is a control mesh made of natural fibre.

In order to improve eco-friendly property of the FRCM, a high content of wasted or recycled material (e.g., at least 70 weight percentages) are used in the cementitious matrix. Moreover, since it takes some time for the cementitious matrix to return to a more viscous state after being applied to the concrete substrate, nanoparticles are added to enhance mechanical and fresh properties of the FRCM. Formula of this sustainable cementitious matrix is described below in detail.

The cementitious matrix is prepared by mixing water and solid materials, where the solid materials contain 30-40 weight percentages binder, 60-70 weight percentages aggregates, and additions. The additions account for 0.5-1.5 weight percentages of the solid materials, and the water for preparing the cementitious matrix is used according to a water-to-binder ratio ranging from 0.35 to 0.45.

The binder can include ordinary Portland cement (OPC) and ground granulated blast-furnace slag (GGBS), and the aggregates can include recycled glass cullets. In this case, the solid materials can contain 20-30 weight percentages OPC, 10-20 weight percentages GGBS and 60-70 weight percentages recycled glass cullets. Among others, the GGBS and the recycled glass cullets are regarded as the wasted or recycled material. Glass cullet has been proven to have good mechanical property as compared to natural sand, and the cementitious matrix containing the recycle glass cullets can achieve low drying shrinkage at about 300 microstrains at the 28^{th} day. This drying shrinkage is much lower than that in the prior art, which drying shrinkage in the prior art ranges from 500-600 microstrains at the 28^{th} day. Such low drying shrinkage of the cementitious matrix can enhance compatibility between the FRCM and the concrete substrate. To achieve proper finish and mechanical properties, the recycled glass cullet used in the cementitious matrix has a maximum particle size of about 2.36 mm. Ordinary Portland cement used in this formulation is grade 42.5 or above and the GGBS is grade 80 or above.

The additions mainly function as improving durability, application properties and/or mechanical properties of the FRCM. In one example, the additions can include nanoparticles at 0.5-2.0 weight percentages of the binder, superplasticizer at 0.2-0.5 weight percentages of the binder, hydroxyl propyl methyl cellulose (HPMC) at 0.1-1.0 weight percentages of the solid materials, and/or starch ether at 0.05-0.1 weight percentages of the solid material.

The nanoparticles can contain nano-silica particles and/or nano-clay particles respectively at 0.5-1.0 weight percentages of the binder. Nano-silica particles are mixed with the cementitious matrix for improving bonding strength between the concrete substrate 20 and the FRCM 10. The nano-clay particles are added to improve rheology to facilitate the application of the cementitious matrix. The nano-clay particles are also used to change thixotropy of the cementitious matrix to regulate a flocculation rate without polymer modification. In this disclosure, the thixotropy can be increased by about 50% when incorporating the nano-clay particles at 1 weight percentages of the binder. To produce the cementitious matrix with the nanoparticles, five minutes dry mixing is adopted before adding mixed water and some other additions such as superplasticizer below.

The HPMC and the starch ether are incorporated in the cementitious matrix to improve slip resistance for vertical and overhead applications. Besides, specific examples for the superplasticizer are well-known for the person skilled in the art, and any known product for the superplasticizer can be used as one of the additions here.

As described above, the FRCM is bonded to the concrete substrate through the bonding agent without polymer modification of the cementitious matrix. In this disclosure, an inorganic bonding agent is used, which can be consisted of metal silicate, silane and nano-silicate. In one example, the metal silicate, the silane and the nano-silicate can be combined in accordance with the following ration: metal silicate:silane:nano-silicate=1:0.2:0.5. A minimum tensile bond strength between the cementitious matrix and the concrete substrate is at least 1.5 MPa under the action of the bonding agent in this disclosure. This bonding agent can further cooperate with nanoparticles within the cementitious matrix to enhance the bond strength. The nano-silicate particles can react with the alkaline inside the concrete substrate 20 to form calcium-silicate-hydrate known as Pozzolanic reaction. The silane contained in the bonding agent has good penetration capability into the concrete substrate, and thus it can act as carrying agent of the nano-silicate particles into the pore of the concrete substrate. Specific examples for the metal silicate, the silane and the nano-silicate are well-known for the person skilled in the art, and their descriptions are omitted in this disclosure, while the person skilled in the art can select any known product for preparing the bonding agent as required.

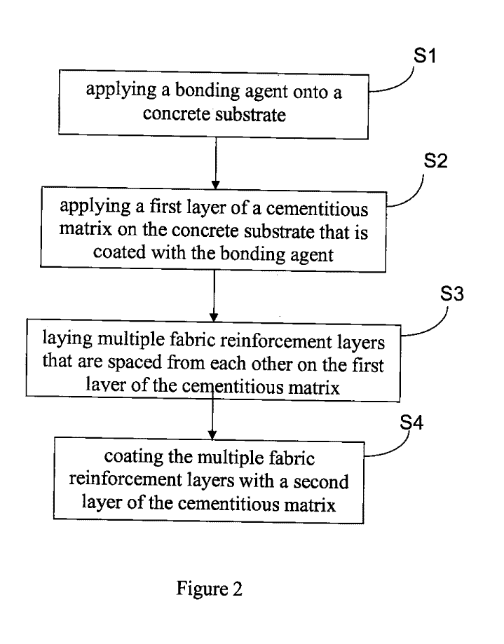

In another aspect of this disclosure, a method is provided for applying a fabric reinforced cementitious matrix described above to a concrete substrate. The FRCM can form the structure as shown in FIG. 1 after a fixed time. Referring to FIG. 2, the method can include following steps S1-S4.

In step S1, a bonding agent is applied onto the concrete substrate. It is preferred that all the defective concrete is removed until the sound concrete substrate is exposed. The concrete substrate is further cleaned to remove any dust, concrete fragments and/or contaminants before applying the bonding agent, such that a bonding effect may not be affected between the FRCM and the concrete substrate. It is mentioned above that there can be no bonding agent when the concrete substrate to be repaired is rough enough.

In step S2, a first layer of a cementitious matrix is applied on the concrete substrate till reinforcement is not exposed. This layer of the cementitious matrix is coupled with the concrete substrate by the bonding agent.

In step S3, multiple fabric reinforcement layers that are spaced from each other are laid on the first layer of the cementitious matrix. Each of the multiple layers is interlaced with each other by a further layer of the cementitious matrix. Specifically, the multiple fabric reinforcement layers may include one or more first fabric layer(s) for load carrying and one or more second fabric layer(s) for crack control. The step S3 can refer to: applying one layer of the cementitious matrix having a thickness of at least 5 mm between each of the first fabric layer(s) and the second fabric layer(s), such that the fabric layer and the layer of the cementitious matrix are interlaced with each other.

In step S4, a second layer of the cementitious matrix is further applied after a last fabric reinforcement layer is laid to form an outer surface of the repaired structure, such that all the multiple fabric reinforcement layers are embedded within the cementitious matrix.

In an example, the steps S3-S4 can include: laying a first layer of tailored man-made fabric on the first layer of cementitious matrix, applying a second layer of cementitious matrix of 5-10 mm thickness, laying a second layer of tailored man-made fabric on the second layer of cementitious matrix, applying a third layer of cementitious matrix of 5-10 mm thickness on the second fabric layer, laying a third layer of tailored natural fabric on the third layer of cementitious matrix, and applying a final layer of cementitious matrix of 5-10 mm thickness to finish the strengthening.

Below some specific examples are used to explain the FRCM of this disclosure.

### Example 1

One example of an FRCM consists of cementitious matrix, two layers of basalt fabric reinforcement and one layer of flax fabric reinforcement. Mix formulation for cementitious matrix consists of 25 weight percentage OPC, 10 weight percentage GGBS and 65 weight percentage recycled glass cutlets with a particle size of 1.18 mm. Water-to-binder ratio is 0.4. Superplasticizer is added at 0.5 weight percentage of the binder. HPMC and starch ether are added at 0.5 and 0.05 weigh percentage of solid materials. Dry mixing is first performed on those solid materials (that is, the binder consisted of OPC and GGBS, the aggregates, three additions), the water is then added into the mixed solid materials to form a mortar. Regarding the fabric, basalt fabric with 200 g/m² weaving density and 5 mm opening is used. A type of natural flax fabric with 75 g/m² weaving density and 5 mm opening is used. The two layers of the basalt fabric reinforcement and the one layer of the flax fabric reinforcement are respectively spaced by one layer of the cementitious matrix.

### Example 2

Another example of an FRCM consists of cementitious matrix, two layers of basalt fabric reinforcement and one layer of cotton fabric reinforcement. The cementitious matrix contains 20 weight percentage OPC, 20 weight percentage GGBS and 60 weight percentage recycled glass with a particle size of 2.36 mm. Water-to-binder ratio is 0.4. Superplasticizer is added at 0.5 weight percentage of the binder. HPMC and starch ether are added at 0.5 and 0.05 weigh percentage of solid material. In addition, nano-clay at 1 weight percentage of the binder is supplemented. The preparation process of the cementitious matrix is the same as that in the example 1, except that the nano-clay is further added during the dry mixing. Regarding the fabric, the basalt fabric with 140 g/m² weaving density and 10 mm opening is used. A type of natural cotton fabric with 100 g/m² weaving density and 10 mm opening is used.

### Example 3

The third example of an FRCM consists of cementitious matrix, two layers of glass fabric reinforcement and one layer of flax fabric reinforcement. Cementitious matrix contains 25 weight percentage OPC, 10 weight percentage GGBS and 65 weight percentage recycled glass with a particle size of 1.18 mm. Water-to-binder ratio is 0.4. Superplasticizer is added at 0.5 weight percentage of the binder while HPMC is added at 0.5 weigh percentage of solid material. In addition, nano-silica at 1 weight percentage of the binder is added. The preparation process of the cementitious matrix is the same as that in the example 1, except that the nano-silica is further added during the dry mixing. Regarding the fabric, glass fabric with 125 g/m² weaving density and 5 mm opening is used. A type of natural flax fabric with 75 g/m² weaving density and 5 mm opening is used.

Durability tests are carried out according to an Acceptance Criteria for Masonry and Concrete Strengthening Using Fiber-reinforced Cementitious Matrix (FRCM) Composite Systems, Subject AC434-1011-R1 (ME/BG) (AC 434 (2011) in short) for the FRCMs in the examples 1-3. Water resistance, saltwater resistance and alkali resistance (at pH 9.5 or higher) of the FRCM are respectively tested in 1000-hour durability tests as well as 20 freeze-thaw cycles (between −18□ and 37.7° C.) durability test. After that, tensile strength, tensile modulus, elongation and interlaminar shear strength of the FRCM are measured according to the AC 434 (2011) to be compared to those of their corresponding control group (which refers to the corresponding FRCM before any durability test). The measured results are respectively recorded in the table 1 below. It can be shown that the tensile strength, tensile modulus, elongation and interlaminar shear strength of the FRCM are at least 85% of the control, which proves excellent strengthening/repair property of the FRCM in this disclosure.

TABLE 1
Properties for Different FRCMs

| | Tensile | Tensile | | Interlaminar |
|---|---|---|---|---|
| | Strength | Modulus | | Shear Strength |
| | (MPa) | (GPa) | Elongation | (MPa) |
| Control group | 5.66 | 10.1 | 0.045% | 1.76 |
| Water | 5.11 | 9.9 | 0.051% | 1.54 |
| Salt water | 6.44 | 13.9 | 0.051% | 1.76 |
| Alkali | 5.61 | 8.7 | 0.065% | 2.16 |
| Freeze-thaw | 7.32 | 11.4 | 0.050% | 1.95 |

The FRCMs in this disclosure combine the load-carrying fabric layer with the crack-control fabric layer for achieving both structure strengthening and fire resistance.

1. A fabric reinforced cementitious matrix, which is capable of being applied to a concrete substrate through a bonding agent, comprising: a cementitious matrix and multiple fabric reinforcement layers; wherein the multiple fabric reinforcement layers are embedded within the cementitious matrix.

2. The fabric reinforced cementitious matrix of claim 1, wherein the multiple fabric reinforcement layers comprises one or more first fabric layer(s) for load carrying and one or more second fabric layer(s) for crack control; the first fabric layer(s) and the second fabric layer(s) are located separately from each other within the cementitious matrix.

3. The fabric reinforced cementitious matrix of claim 2, wherein the cementitious matrix comprises an inner surface and an outer surface; the one or more first fabric layer(s) are located adjacent to the inner surface of the cementitious matrix, and the one or more second fabric layer(s) are located adjacent to the outer surface of the cementitious matrix.

4. The fabric reinforced cementitious matrix of claim 2, wherein the one or more first fabric layer(s) is/are made of woven or unwoven man-made basalt or glass fibre, and/or the one or more second fabric layer(s) is/are made of woven or unwoven natural flax or cotton fiber.

5. The fabric reinforced cementitious matrix of claim 1, wherein the cementitious matrix has a thickness of substantially 10 mm-40 mm, and spacing between each of the multiple fabric reinforcement layers is at least 4 mm; and/or wherein the multiple fabric reinforcement layers are substantially arranged in parallel with surfaces of the cementitious matrix.

6. The fabric reinforced cementitious matrix of claim 1, wherein the cementitious matrix is prepared by mixing water and solid materials, which solid materials comprise 30-40 weight percentages binder, 60-70 weight percentages aggregates and additions; wherein the additions account for 0.5-1.5 weight percentages of the solid materials, and a weight ratio between the water and the binder ranges from 0.35 to 0.45;

7. The fabric reinforced cementitious matrix of claim 6, wherein the binder consists of ordinary Portland cement and ground granulated blast-furnace slag, and the aggregates are recycled glass cullets; the solid materials comprises 20-30 weight percentages ordinary Portland cement, 10-20 weight percentages ground granulated blast-furnace slag, and 60-70 weight percentages recycled glass cullets.

8. The fabric reinforced cementitious matrix of claim 7, wherein the recycled glass cullets have a maximum particle size of substantially 2.36 mm.

9. The fabric reinforced cementitious matrix of claim 7, wherein the cementitious matrix has a dry shrinkage of less than 300 microstrain at a 28^{th} day.

10. The fabric reinforced cementitious matrix of claim 6, wherein the additions comprises nanoparticles at 0.5-2.0 weight percentages of the binder, superplasticizer at 0.2-0.5 weight percentages of the binder, hydroxyl propyl methyl cellulose at 0.1-1.0 weight percentages of the solid materials, and/or starch ether at 0.05-0.1 weight percentages of the solid material.

11. The fabric reinforced cementitious matrix of claim 10, wherein said nanoparticles comprise nano-silica particles and/or nano-clay particles respectively at 0.5-1.0 weight percentages of the binder.

12. The fabric reinforced cementitious matrix of claim 1, wherein the cementitious matrix comprises at least 70 weight percentages wasted or recycled materials.

13. The fabric reinforced cementitious matrix of claim 12, wherein the wasted or the recycled materials comprise ground granulated blast-furnace slag and recycled glass cullets.

14. The fabric reinforced cementitious matrix of claim 1, wherein the bonding agent is consisted of metal silicate, silane and nano-silicate.

15. The fabric reinforced cementitious matrix of claim 14, wherein when the matrix is applied to the concrete substrate, the bonding agent is intermediate between the concrete substrate and the cementitious matrix to bond the two together; minimum tensile bond strength between the cementitious matrix and the concrete substrate is at least 1.5 MPa at a 28^{th} day.

16. A fabric reinforced cementitious matrix, which is capable of being applied to a concrete substrate, comprising a cementitious matrix and multiple fabric reinforcement layers embedded within the cementitious matrix; the cementitious matrix comprises at least 70 weight percentages wasted or recycled materials; the multiple fabric reinforcement layers comprises one or more first fabric layer(s) for load carrying and one or more second fabric layer(s) for crack control, wherein the first fabric layer(s) and the second fabric layer(s) are respectively located adjacent to an inner side and an outer side of the cementitious matrix.

17. The fabric reinforced cementitious matrix of claim 16, wherein the wasted or the recycled materials comprise ground granulated blast-furnace slag and recycled glass cullets; the recycled glass cullets have a maximum particle size of substantially 2.36 mm.

18. The fabric reinforced cementitious matrix of claim 16, wherein the cementitious matrix further comprises nanoparticles, said nanoparticles comprise nano-silica particles and/or nano-clay particles.

19. The fabric reinforced cementitious matrix of claim 16, wherein the one or more first fabric layer(s) is/are made of woven: or unwoven man-made basalt or glass fibre, and/or the one or more second fabric layer(s) is/are made of woven or unwoven natural flax or cotton fiber.

20. A method for applying a fabric reinforced cementitious matrix, comprising:
applying a bonding agent onto a concrete substrate;
applying a first layer of a cementitious matrix on the concrete substrate that is coated with the bonding agent;
laying multiple fabric reinforcement layers on the first layer of the cementitious matrix, and
coating the multiple fabric reinforcement layers with a second layer of the cementitious matrix, such that the multiple fabric reinforcement layers are embedded within the cementitious matrix;
wherein the multiple fabric reinforcement layers comprise one or more first fabric layer(s) for load carrying and one or more second fabric layer(s) for crack control, the method further comprises: applying one layer of the cementitious matrix having a thickness of at least 5 mm between each of the first fabric layer(s) and the second fabric layer(s), such that the fabric layer and the layer of the cementitious matrix are interlaced with each other.
